(19) United States
(12) Patent Application Publication
(10) Pub. No.: US 2007/0131038 A1
(43) Pub. Date: Jun. 14, 2007

(54) REAL-TIME PARTICULATE MATTER MEASURING SYSTEM

(76) Inventors: Qiang Wei, Novi, MI (US); Karl E. Oestergaard, Saline, MI (US); Ichiro Asano, Konan-shi (JP); Leslie Hill, Kenilworth (GB)

Correspondence Address: BROOKS KUSHMAN P.C., 1000 TOWN CENTER, TWENTY-SECOND FLOOR, SOUTHFIELD, MI, 48075, US

(21) Appl. No.: 11/275,098

(22) Filed: Dec. 9, 2005

(51) Int. Cl. G01N 1/22; G01N 15/00

(52) U.S. Cl. 73/865.5; 73/863.12

(57) ABSTRACT

A real-time particulate matter measuring system includes a hot diluter for receiving and diluting aerosol. An evaporation unit receives the diluted aerosol. A cold diluter receives and dilutes the output flow from the evaporation unit. A condensation particle counter receives the diluted output flow and measures the particle number concentration. An integrated device also receives the diluted output flow. The integrated device measures at least one of particle diameter concentration and particle surface area. The integrated device also measures mass concentration.

### BACKGROUND OF THE INVENTION

1. Field of the Invention

The invention relates to real-time particulate matter measuring systems.

2. Background Art

Particulate matter (PM) emitted by combustion engines causes public health and environmental concerns. Strict emission standards have been legislated to reduce the emission of pollutants from the combustion engines. Recently, studies have found that the mass based PM emissions from engines, with modern techniques, have been reduced significantly. However, the number concentrations of PM emissions from engines have been increased significantly. As a result, emitted particles have smaller sizes, and larger surface areas. When studying engine emitted particles, it is very important to measure the particles correctly.

An existing approach to measuring solid particle number emissions from light-duty diesel vehicles is illustrated in FIG. 1 at 10. System 10 includes a pre-classifier 12, hot diluter (PND1) 14, evaporation tube 16, cold diluter (PND2) 18, and a condensation particle counter (CPC) 20. Pre-classifier 12 is used to keep the cutoff size of aerosol in the range of 2.5 to 10 μm. By running hot diluter 14 at high dilution air temperature, and heating the sample in the range of 300 to 400° C. in evaporation tube 16, particles formed by volatile material and sulfate particles are vaporized to gas phase. During cold dilution with cold diluter 18, all particles formed by volatile material and sulfate are removed. As a result, only solid particles move into condensation particle counter (CPC) 20. The concentration of the solid particles is measured at CPC 20.

Although existing systems for measuring particulate matter are used in many applications, these systems have limited functionality. This is a need for a real-time particulate measuring system that has extended functionality.

### SUMMARY OF THE INVENTION

It is an object of the invention to provide a powerful tool for measuring engine exhaust particle characteristics that can be used for engine combustion and exhaust after-treatment research.

According to the invention, a real-time particulate matter measuring system has extended functionality beyond that of the existing approaches to measuring solid particle number emissions. The invention involves integrating a diffusion charger or particle diameter concentration measuring instrument into a solid particle counting system (SPCS). The contemplated system may generate up to seven real-time particle characteristics instead of only one for either solid particles or total particles.

A real-time particulate matter measuring system made in accordance with the invention involves a pre-classifier, hot diluter, evaporation tube or unit, cold diluter, and condensation particle counter. The system further comprises an integrated device for measuring mass concentration, and either particle diameter concentration or particle surface area.

In one approach, a diffusion charger (DC) is integrated into the solid particle counting system. In another approach, a particle diameter concentration measuring instrument is integrated into the solid particle counting system. In either of these approaches, the real-time particulate matter measuring system is able to provide up to at least seven characteristics instead of one for engine emitted solid particles or total particles. These characteristics include real-time solid particle or total particle number concentration, surface area, diameter concentration, mass concentration, volume concentration, average diameter, and average effective density.

The diffusion charger (DC) is a type of sensor for measuring particle surface area in real-time. By calibrating the diffusion charger with the conventional PM mass measurement, the diffusion charger can measure real-time mass concentration simultaneously.

The diameter concentration instrument operates under a similar principle as the diffusion charger. The diameter concentration instrument measures particle diameter concentration (for example, mm/cm³) and is calibrated to measure particle diameter concentration instead of surface area. In the same way as the diffusion charger, the diameter concentration instrument may be calibrated to measure real-time mass concentration simultaneously.

In a measuring system with the diffusion charger, the condensation particle counter in the system provides the solid particle or total particle number concentration. The diffusion charger measure the real-time surface area and mass concentration for solid particles or total particles. The average diameter, diameter concentration, volume concentration, and average effective density for solid particles or total particles can be calculated from the information obtained from the condensation particle counter and diffusion charger.

In a system with the diameter concentration instrument, the condensation particle counter measures the solid or total particle number concentration. The diameter concentration instrument measures particle diameter concentration and mass concentration for solid or total particles. The average diameter, surface area, volume concentration, and average effective density for solid or total particles can be calculated from the information obtained from the condensation particle counter and diameter concentration instrument.

The advantages associated with embodiments of the invention are numerous. For example, the diffusion charger or diameter concentration instrument may take samples at the same place as the condensation particle counter. In this way, excessive modification to the solid particle counting system is not required to implement a real-time particulate matter measuring system in accordance with the invention. The improved system provides a powerful tool for measuring particle characteristics with greatly increased functionality.

### BRIEF DESCRIPTION OF THE DRAWINGS

FIG. 1 illustrates an existing solid particle counting system;

FIG. 2 illustrates a real-time particulate matter measuring system made in accordance with a first embodiment of the invention; and

FIG. 3 illustrates a real-time particulate matter measuring system made in accordance with a second embodiment of the invention.

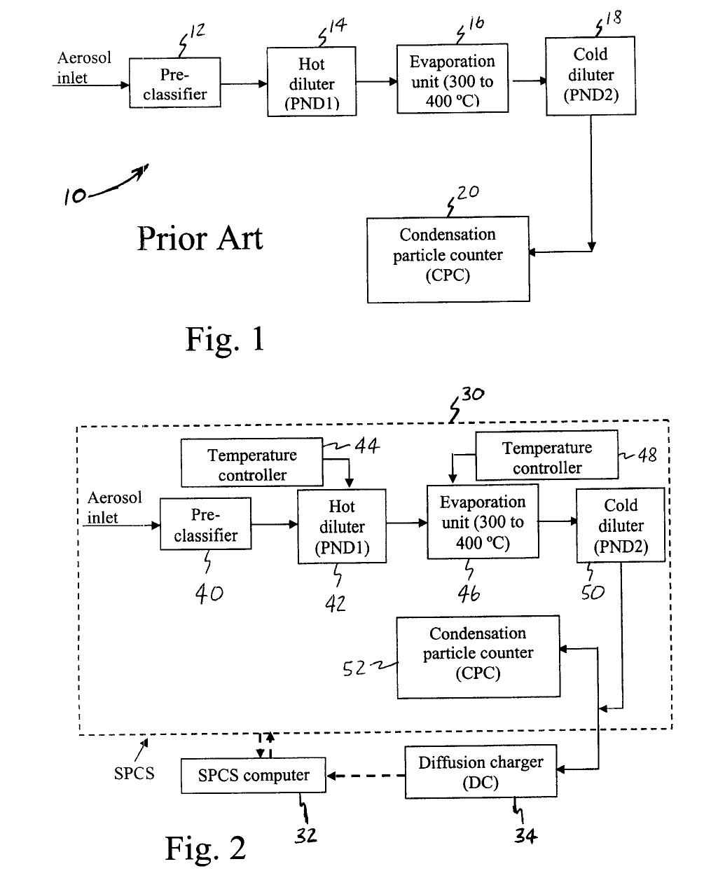

### DETAILED DESCRIPTION OF THE PREFERRED EMBODIMENTS

With reference to FIG. 2, the real-time particulate matter measuring system includes solid particle counting system (SPCS) 30, SPCS computer 32, and diffusion charger (DC) 34. SPCS 30 includes pre-classifier 40, hot diluter (PND1) 42 and associated temperature controller 44, evaporation unit 46 and associated temperature controller 48, cold diluter (PND2) 50, and condensation particle counter (CPC) 52. Pre-classifier 40 is used to keep the cut-off size of aerosol in the range of 2.5 to 10 μm. By running hot diluter 42 at high dilution air temperature with temperature controller 44, and heating the sample in the range of 300 to 400° C. in evaporation unit 46, particles formed by volatile material and sulfate particles are vaporized to gas phase. Following cold dilution at cold diluter 50, all particles formed by volatile material and sulfate are removed. Solid particles move into CPC 52, and concentration of the solid particles is measured at CPC 52. In the case where hot diluter 42 and evaporation unit 46 are run at lower temperature to avoid vaporization of volatile material and sulfate particles to gas phase, all particles move into CPC 52 with the flow, and total particle concentration is measured at CPC 52.

By connecting the inlet of diffusion charger 34 to the upstream side of CPC 52 in the SPCS 30, diffusion charger 34 takes samples at the same place as CPC 52. The computer control and data acquisition system 32 for SPCS 30 is used to obtain signals from diffusion charger 34, which is calibrated to measure surface area and mass concentration in real-time. Different calibration curves for mass concentration on solid and total particles with diffusion charger 34 can be stored in the SPCS computer 32. For example, the calibration curve for solid particle mass concentration is selected when the hot diluter and evaporation unit in the SPCS run at high temperature. Otherwise, the calibration curve for total particle mass concentration is selected.

As described above, CPC 52 measures number concentration, and DC 34 measures surface area and mass concentration in real-time. The average diameter, diameter concentration, volume concentration, and average effective density for measured particles, either solid or total particles, can be calculated as:

$$\begin{matrix}{D}_{p ( t - td )} = \sqrt{\frac{{S}_{t - td}}{π {N}_{t}}} \\ {L}_{t - td} = {D}_{p ( t - td )} {N}_{t} \\ {V}_{t - td} = \frac{1}{6} π {D}_{p ( t - td )}^{3} {N}_{t} \\ {ρ}_{eff ( t - td )} = \frac{{m}_{t - td}}{{V}_{t - td}}\end{matrix}$$

where td is the delay time of the CPC against the DC; D_{p(t-td)} is average diameter for surface area at time t−td; S_{t-td} is surface area measured with the DC at time t−td; Nₜ is the number concentration measured by the CPC at time t; L_{t-td} is particle diameter concentration at time t−td; V_{t-td} is volume concentration at time t−td; ρ_{eff(t-td)} is the average effective density at time t−td; m_{t-td} is the mass concentration measured by the DC at time t−td.

With the current technique, the response time of the DC is much faster than that of the CPC. Therefore, there is a delay time correction involved in the above equations. Delay time td can be measured by running the real-time particulate matter measuring system under transient conditions. It is a constant at the fixed system configuration.

In summary, there are seven functions obtained from this embodiment of the real-time particulate matter measuring system:
1. Number concentration
2. Particle diameter concentration
3. Surface area
4. Mass concentration
5. Average diameter
6. Volume concentration
7. Average effective density

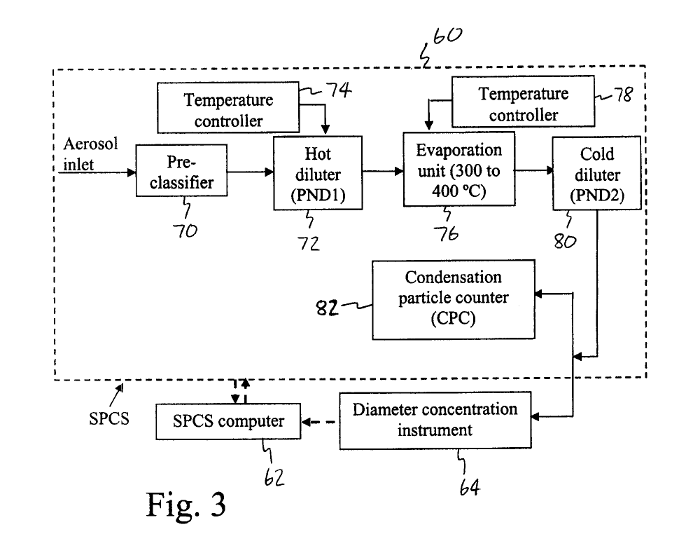

With reference to FIG. 3, the real-time particulate matter measuring system includes SPCS 60, SPCS computer 62, and diameter concentration instrument 64. SPCS 60 includes pre-classifier 70, hot diluter (PND1) 72 and associated temperature controller 74, evaporation unit 76 and associated temperature controller 78, cold diluter (PND2) 80, and condensation particle counter (CPC) 82.

The inlet of diameter concentration instrument 64 is connected to the upstream side of CPC 82 in the SPCS 60. Diameter concentration instrument 64 takes samples at the same place as CPC 82. The computer control and data acquisition system 62 for SPCS 60 is used to obtain signals from diameter concentration instrument 64, which is calibrated to measure particle diameter concentration and mass concentration in real-time. Different calibration curves for mass concentration on solid and total particles with diameter concentration instrument 64 can be stored in SPCS computer 62. For example, the calibration curve for solid particle mass concentration is selected when the hot diluter and evaporation unit in the SPCS run at high temperature. Otherwise, the calibration curve for total particle mass concentration is selected.

CPC 82 measures particle number concentration. The diameter concentration instrument 64 measures diameter concentration and mass concentration in real-time. The average diameter, surface area, volume concentration, and average effective density for measured particles, either solid or total particles, can be calculated as:

$$\begin{matrix}{D}_{p ( t - td )} = \frac{{L}_{t - td}}{{N}_{t}} \\ {S}_{t - td} = π {D}_{p ( t - td )}^{2} {N}_{t} \\ {V}_{t - td} = \frac{1}{6} π {D}_{p ( t - td )}^{3} {N}_{t} \\ {ρ}_{eff ( t - td )} = \frac{{m}_{t - td}}{{V}_{t - td}}\end{matrix}$$

where td is the delay time of the CPC against the diameter concentration instrument; D_{p(t-td)} is average diameter for particle diameter concentration at time t−td; L_{t-td} is particle diameter concentration measured with the diameter concentration instrument at time t−td; S_{t-td} is surface area at time t−td; Nₜ is the number concentration measured by the CPC at time t; V_{t-td} is volume concentration at time t−td; ρ_{eff(t-td)} is the average effective density at time t−td; m_{t-td} is the mass concentration measured by the diameter concentration instrument at time t−td.

The delay time of the CPC against the diameter concentration instrument, td, can be measured by running the real-time particulate matter measuring system under transient conditions. If there is no delay time between the CPC and the diameter concentration instrument, td is equal to zero. The sign (negative and positive) of td reflects that the diameter concentration instrument either faster or slower than the CPC.

In summary, there are seven functions obtained from this embodiment of the real-time particulate matter measuring system:
1. Number concentration
2. Particle diameter concentration
3. Surface area
4. Mass concentration
5. Average diameter
6. Volume concentration
7. Average effective density
   The following procedures may be used to measure either solid or total particles in the illustrated embodiments:
a. Solid particle measurement: The temperature controllers for the hot diluter and evaporation unit are set at high temperatures. For example, the temperature controller for the hot diluter is set at a temperature higher than 150° C., and the temperature controller for the evaporation unit is set at 300 to 400° C. Thus, particles formed by volatile material and sulfur compound are removed. The CPC and diffusion charger (DC) or diameter concentration instrument measure solid particles only. To avoid saturation of the CPC and DC or diameter concentration instrument, the dilution ratios for the hot diluter and the cold diluter can be adjusted to higher values.
b. Total particle measurement: The temperature controllers for the hot diluter and evaporation unit are set at room temperature or turned off. As a result, total particles including solid, volatile, and sulfur compound particles flow into the CPC and diffusion charger (DC) or diameter concentration instrument. To avoid saturation of the CPC and DC or diameter concentration instrument, the dilution ratios for the hot diluter and the cold diluter can be adjusted to higher values.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A real-time particulate matter measuring system, the system comprising:
a hot diluter for receiving and diluting aerosol;
an evaporation unit for receiving the diluted aerosol, the evaporation unit being capable of evaporating volatile material particles and sulphate particles, the evaporation unit providing an output flow;
a cold diluter for receiving and diluting the output flow from the evaporation unit;
a condensation particle counter for receiving the diluted output flow from the cold diluter and measuring the particle number concentration; and
an integrated device for measuring mass concentration, and for measuring at least one of particle diameter concentration and particle surface area, the integrated device receiving the diluted output flow from the cold diluter.

2. The system of claim 1 further comprising:
a pre-classifier for receiving the aerosol, and providing pre-classified aerosol to the hot diluter.

3. The system of claim 1 wherein the integrated device is a diffusion charger for measuring particle surface area of the diluted output flow.

4. A method of operating the system of claim 3, the method comprising:
determining the particle diameter concentration of the diluted output flow.

5. A method of operating the system of claim 3, the method comprising:
determining the particle average diameter of the diluted output flow.

6. A method of operating the system of claim 3, the method comprising:
determining the particle volume concentration of the diluted output flow.

7. A method of operating the system of claim 3, the method comprising:
determining the average effective density of the diluted output flow.

8. The system of claim 1 wherein the integrated device is a particle diameter concentration instrument for measuring particle diameter concentration of the diluted output flow.

9. A method of operating the system of claim 8, the method comprising:
determining the particle surface area of the diluted output flow.

10. A method of operating the system of claim 8, the method comprising:
determining the particle average diameter of the diluted output flow.

11. A method of operating the system of claim 8, the method comprising:
determining the particle volume concentration of the diluted output flow.

12. A method of operating the system of claim 8, the method comprising:
determining the average effective density of the diluted output flow.

13. A method of operating the system of claim 1, the method comprising:
operating the hot diluter and the evaporation unit at a sufficiently high temperature to cause evaporation of volatile material particles and sulphate particles.

14. A method of operating the system of claim 1, the method comprising:
operating the hot diluter and the evaporator unit at a sufficiently low temperature to avoid evaporation of volatile material particles and sulphate particles.
